(19) United States
(12) Patent Application Publication
(10) Pub. No.: US 2018/0186278 A1
(43) Pub. Date: Jul. 5, 2018

(54) SMART BEAM LIGHTS FOR DRIVING AND ENVIRONMENT ASSISTANCE

(71) Applicant: Faraday&Future Inc., Gardena, CA (US)

(72) Inventors: Xiufeng Song, San Jose, CA (US); Christopher Keir Campbell, Cupertino, CA (US)

(21) Appl. No.: 15/690,165

(22) Filed: Aug. 29, 2017

Related U.S. Application Data
(60) Provisional application No. 62/381,101, filed on Aug. 30, 2016.

(51) Int. Cl. B60Q 1/08; B60Q 1/00; B60Q 1/076; B60Q 1/24

(52) U.S. Cl. CPC B60Q 1/085; B60Q 1/0023; B60Q 2300/42; B60Q 1/24; B60Q 2300/45; B60Q 1/076

(57) ABSTRACT

In certain embodiments, a vehicle headlight system can include at least two independently controlled headlights that can be configured such that a first headlight can be oriented toward a first point-of-interest (POI) and, at the same time, a second headlight can be oriented toward a second POI that is different than the first POI. Some POIs can include various road features (e.g., road contours), signs, moving objects (e.g., people, animals), and the like. The vehicle headlight system can further control various operating characteristics of the one or more headlights including brightness, color, and illumination pattern, to name a few. In some cases, environmental data (e.g., road pitch, roll, and yaw data) and vehicle data (e.g., velocity and acceleration data) can be used to determine which direction to orient the headlights to maintain a proper illumination of the road ahead.

### CROSS-REFERENCE TO RELATED APPLICATIONS

This application claims the benefit of U.S. Provisional Application No. 62/381,101, filed Aug. 30, 2016, the entirety of which is hereby incorporated by reference.

### BACKGROUND

Vehicle headlight technology has advanced over the years in both composition and function. Early headlights have evolved from acetylene to halogen-based lamps and more recently to high-intensity discharge systems (e.g., “xenon” headlamps) and light emitting diodes (LEDs). Some contemporary systems include headlight technology that has progressed far beyond simple fixed modes of illumination including automatic headlights and remote control operations (e.g., typically coupled with vehicle auto-ignition). Better and more adaptive headlight systems are needed.

### SUMMARY

In certain embodiments, a vehicle headlight system for a vehicle includes a first headlight having a first control system to control an orientation of the first headlight, a second headlight having a second control system to control an orientation of the second headlight, and a processor to control the first and second control systems, where the processor is operable to orient the first headlight toward a first point-of-interest (POI), and simultaneously orient the second headlight toward a second POI that is different than the first POI. In some cases, the first POI and the second POI can each include at least one of a road feature, a sign, or a moving object. The processor can further control a brightness of each of the first and second headlights, a color of each of the first and second headlights, and an illumination pattern of each of the first and second headlights. The first and second control systems can be actuator systems to control the orientation of the first and second headlight in two axes of rotation. Certain embodiments can include a global position system (GPS) to receive position data corresponding to a location of the vehicle, and POI data, where the processor uses the POI data, at least in part, to orient the first or second headlight when the first or second POI in included in the POI data.

In some embodiments, a method of operating a vehicle headlight system for a vehicle includes receiving, by a processor, a first sensor input corresponding to a location of a first point-of-interest (POI), and receiving, by the processor, a second sensor input corresponding to a location of a second point-of-interest (POI). The method can further include simultaneously controlling, by the processor, a focus of a first adjustable headlight toward the first POI, and a focus of a second adjustable headlight toward the second POI, where the first POI is different than the second POI. The first POI and the second POI can each include at least one of a road feature, a sign, or a moving object. The method may further include simultaneously controlling, by the processor, at least one of a brightness of each of the first and second adjustable headlights, a color of each of the first and second adjustable headlights, or an illumination pattern of each of the first and second adjustable headlights. Some embodiments can include receiving, by the processor from a GPS, position data corresponding to a location of the vehicle, and POI data, where the controlling of the first and second adjustable headlights is based, in part, on the POI data. The first and second adjustable headlights can be controlled by actuator systems to control the focus of the first and second headlight in two axes of rotation.

In further embodiments, a method of operating a vehicle headlight system for a vehicle can include detecting, by a sensor controlled by a processor, light reflected from a POI, determining, by the processor, a visibility of the POI based on the light reflected from the POI, and changing a color of an adjustable headlight to improve the visibility of the POI. The method can further include receiving, by a processor, a sensor input corresponding to a location of the POI; and controlling, by the processor, an orientation of the adjustable headlight toward the POI. In some implementations, the method can include determining, by the processor, one or more colors associated with the POI based on the light reflected from the POI, and determining, by the processor, a color that, when combined with the one or more colors associated with the POI, improves the visibility of the POI, where changing the color of the adjustable headlight includes changing the color to the determined color.

In certain embodiments, a method of operating a vehicle headlight system for a vehicle includes detecting, by a sensor controlled by a processor, a type of environment the vehicle is operating in, and controlling, by the processor, a light spread pattern of at least one adjustable headlight on the vehicle according to a first light spread pattern when the detected environment is an open-space environment, and a second light spread pattern when the detected environment is a closed-space environment. The closed-space environment may include any one of a tunnel, garage, or enclosed structure.

In some embodiments, a method of operating a lighting system for a vehicle includes receiving, by a processor, crowd-sourced data corresponding to a location of a POI, and controlling, by the processor, an orientation of an adjustable headlight toward the POI. The crowd-sourced data can be received from a cloud-based data source.

In certain embodiments, a method of operating a vehicle headlight system can include receiving road data corresponding to a stretch of road in a vehicle trajectory, the road data including road pitch data, road roll data, and road yaw data. The method can further include controlling, by the processor, an orientation of an adjustable headlight based on the road data, and receiving vehicle data including vehicle velocity data and vehicle acceleration data, where controlling the orientation of the adjustable headlight can be further based on the vehicle data. In some implementations, the method can further include determining, by the processor, a target location to aim the adjustable headlight, and dynamically modulating the orientation of the adjustable headlight in real-time to maintain a focus of the adjustable headlight on the target location as new road data and vehicle data is received.

### BRIEF DESCRIPTION OF THE DRAWINGS

The detailed description is set forth with reference to the accompanying figures.

FIG. 1 shows various shortcomings associated with conventional vehicle headlight systems.

FIG. 2 shows various adaptive enhancements to the headlight system of vehicle 110, according to certain embodiments.

FIG. 3 shows a system for a vehicle having smart beam lights for driving and environment assistance, according to certain embodiments.

FIG. 4 shows a simplified flow chart illustrating a method for controlling adaptive headlights in a vehicle, according to certain embodiments.

FIG. 5 shows a simplified flow chart illustrating a method for improving the visibility of a POI by changing a color of a headlight beam, according to certain embodiments.

FIG. 6 shows a simplified flow chart for a method of operating an adaptive headlight system to dynamically modulate an orientation of a headlight based on high-definition road and vehicle data, according to certain embodiments.

FIGS. 7A and 7B are simplified diagrams showing a cabin view of an adaptive headlight system using colors to enhance a reflected image, according to certain embodiments.

FIGS. 8A and 8B are simplified diagrams showing a cabin view of an adaptive headlight system operating in a closed-space environment, according to certain embodiments.

FIG. 9 shows a simplified diagram of cabin view of an adaptive headlight system providing environment assistance to a pedestrian, according to certain embodiments.

FIG. 10 shows a simplified diagram showing a number of vehicles communicatively coupled through a cloud-based network, according to certain embodiments.

FIG. 11 shows computer system for controlling an adaptive vehicle headlight system, according to certain embodiments.

### DETAILED DESCRIPTION

Aspects of the present disclosure relate generally to vehicular systems, and in particular to smart beam lights for driving and environment assistance, according to certain embodiments.

In the following description, various embodiments of vehicular headlight will be described. For purposes of explanation, specific configurations and details are set forth in order to provide a thorough understanding of the embodiments. However, it will be apparent to one skilled in the art that certain embodiments may be practiced without every disclosed detail. Furthermore, well-known features may be omitted or simplified in order not to obscure the embodiments described herein.

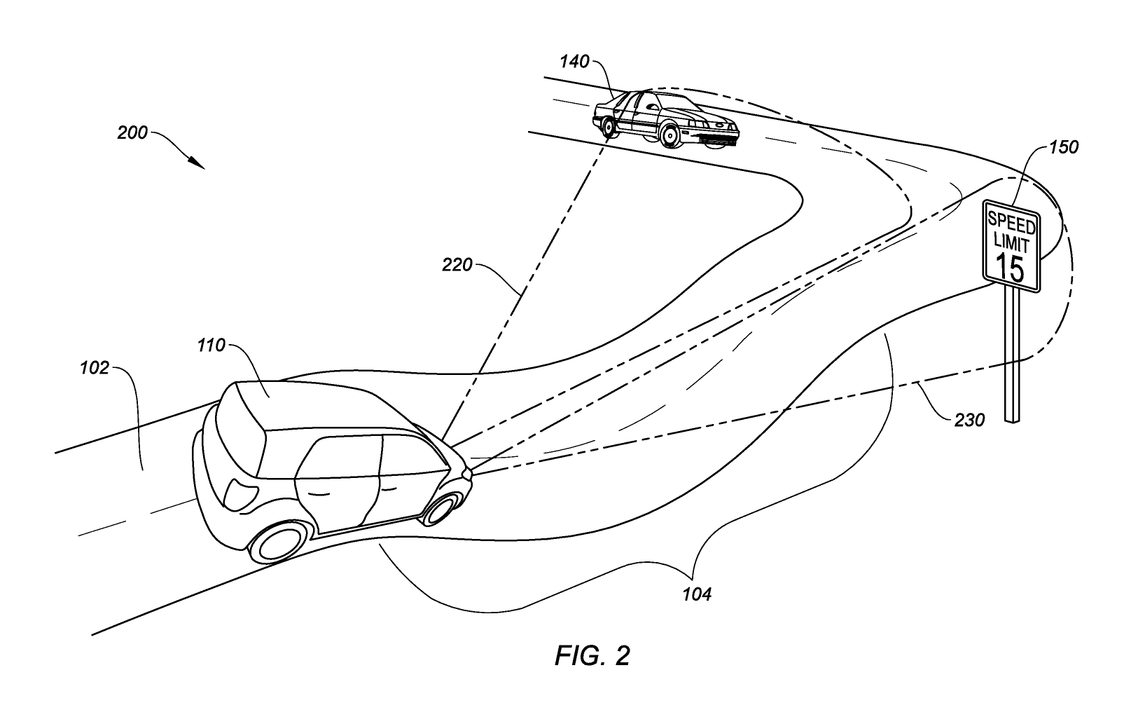

In certain embodiments, a vehicle headlight system can include at least two independently controlled headlights that can be configured such that a first headlight can be oriented toward a first point-of-interest (POI) and, at the same time, a second headlight can be oriented toward a second POI that is different than the first POI. Some POIs can include various road features (e.g., road contours), signs, moving objects (e.g., people, animals), and the like (see, e.g., FIG. 2). The vehicle headlight system can further control various operating characteristics of the one or more headlights including brightness, color, and illumination pattern, to name a few. In some cases, environmental data (e.g., road pitch, roll, and yaw data) and vehicle data (e.g., velocity and acceleration data) can be used to determine which direction to orient the headlights to maintain proper illumination of the road ahead (see, e.g., FIG. 2).

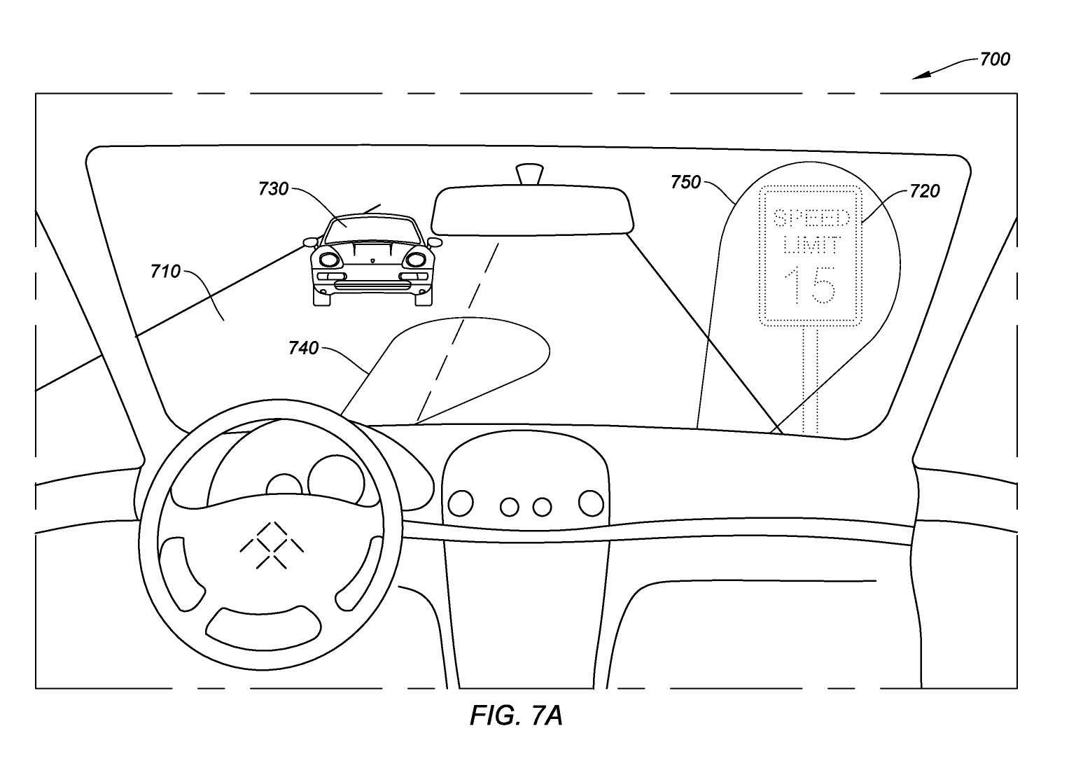

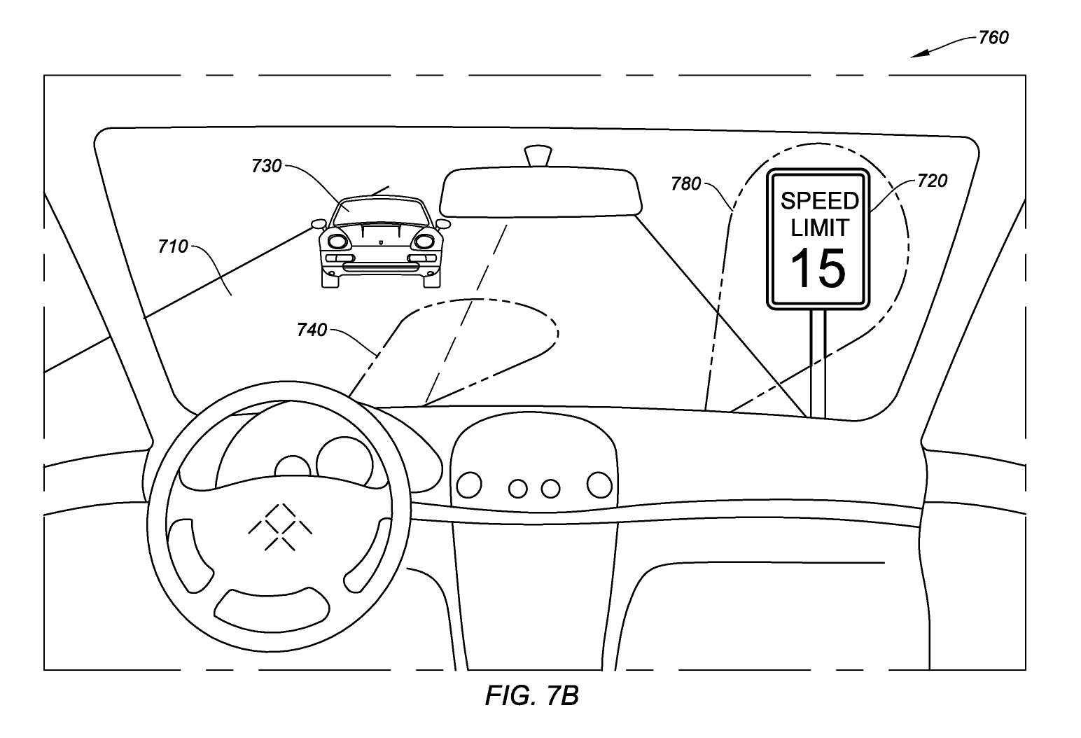

In some embodiments, a color of the vehicle headlights can be changed to improve visibility in certain cases. For instance, a processor can control a sensor to detect light reflected from a POI, determine a visibility and one or more colors associated with the POI based on the reflected light, determine a color that, when combined with the one or more colors associated with the POI, improve the visibility of the POI, and changing the color of the headlight to the determined color (see, e.g., FIGS. 7A-7B).

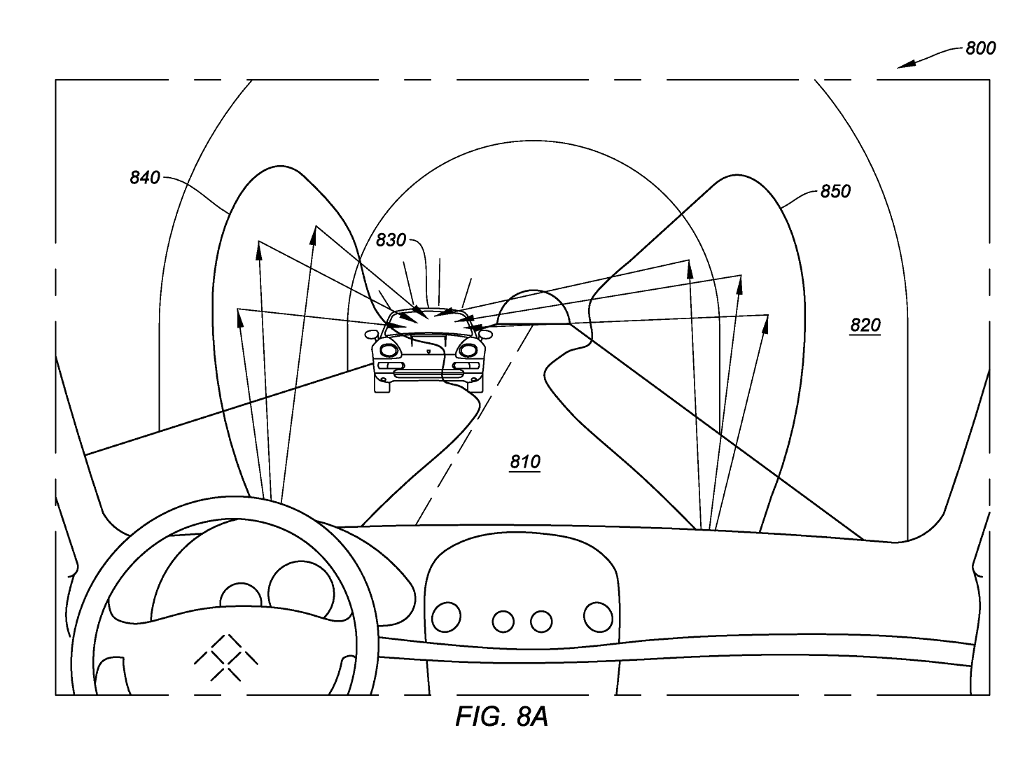

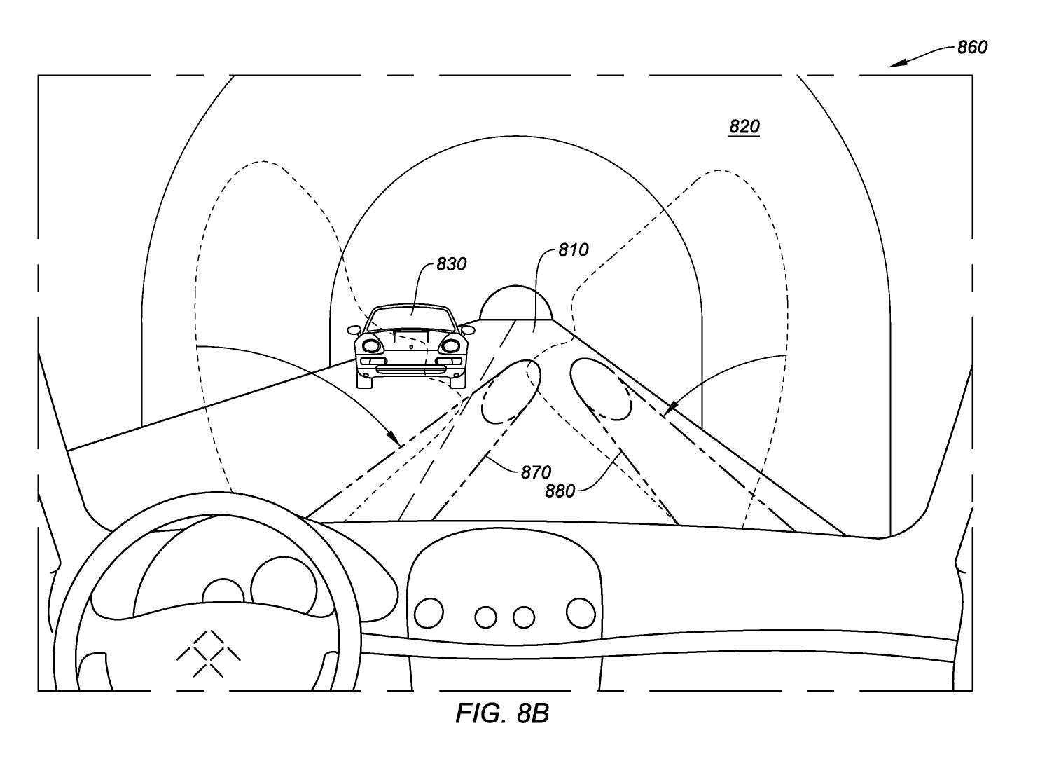

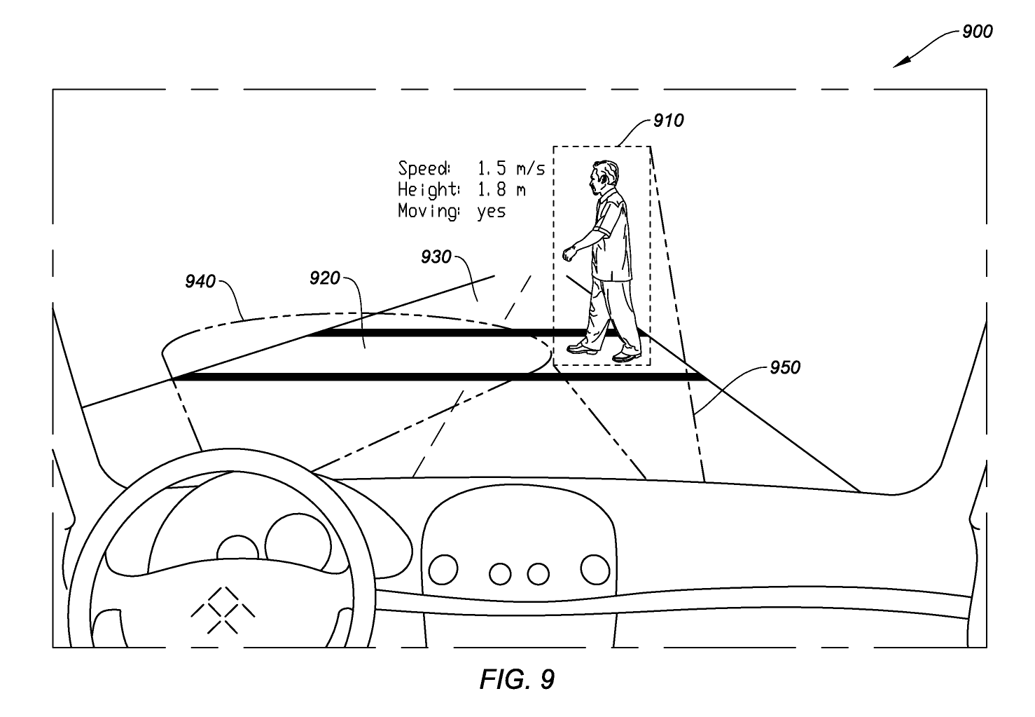

In further embodiments, sensors can be used to detect a type of environment the vehicle is operating in and control a light spread pattern accordingly. For example, in closed-space environments (e.g., tunnel, garage, or enclosed structure), the light spread pattern can be redirected (e.g., narrowed) to prevent unnecessary or distracting lighting that may impair other drivers (see, e.g., FIGS. 8A-8B). In some cases, the light spread pattern can be used to enhance or help others (e.g., pedestrians) by lighting their paths (see, e.g., FIG. 9).

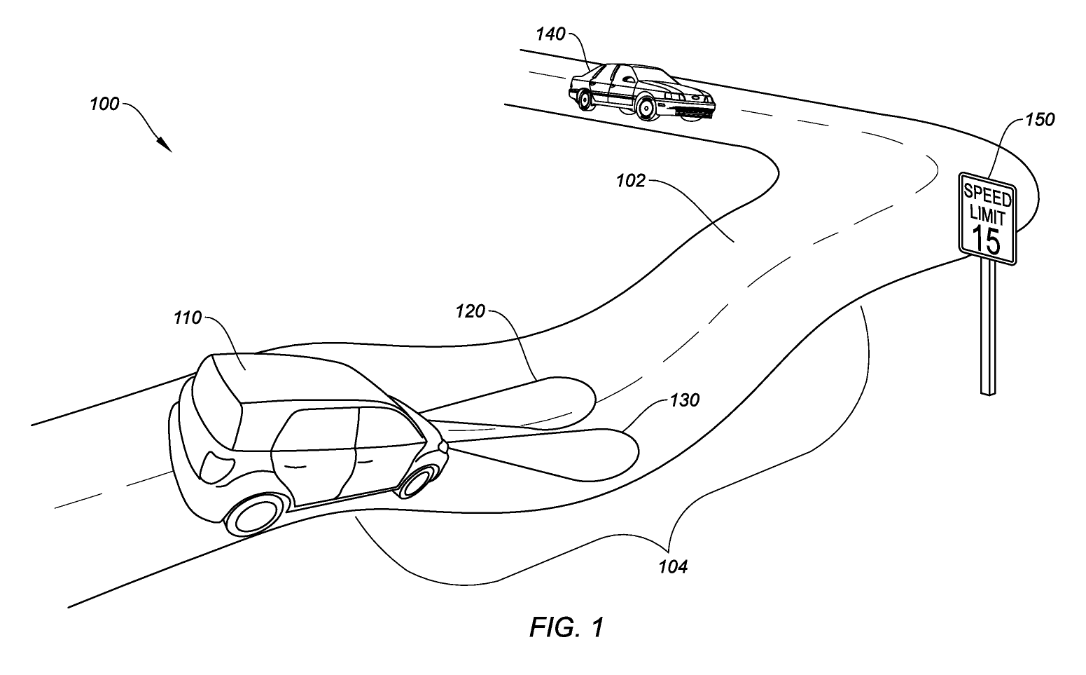

Conventional headlights typically have a fixed alignment and are usually designed to illuminate a large area in front of the vehicle so that the driver can see objects both relatively close to the vehicle and objects further down the road. This may work reasonably well on straight roads, but can be problematic on roads having many curves, dips, and contours. FIG. 1 illustrates some of these problems with conventional systems, and FIG. 2 highlights how certain embodiments of the present invention can resolve these problems.

FIG. 1 shows numerous shortcomings associated with conventional vehicle headlight systems. Environment 100 includes vehicle 110, road 102, approaching vehicle 140, and sign 150. Vehicle 110 includes left headlight beam 120 and right headlight beam 130. Road 102 can include dip 104.

The headlight system of vehicle 110 should preferably provide its driver with ample illumination of the road ahead to allow the driver to see the upcoming contours of the road, street signs, oncoming traffic, and other objects that the driver may have to avoid and/or navigate around (e.g., construction cones, animals, potholes, etc.). Referring to FIG. 1, vehicle 110 is shown entering dip 104 on road 102. Headlights 120 and 130, which would normally be focused sufficiently far down the road on flat road conditions, are instead focused on a portion of road 102 immediately in front of vehicle 110 due to the gradient and contours of dip 104. That is, vehicle 110 is on a downward slope and headlight beams 120 and 130 are illuminating the upward slope of dip 104 instead of the road further ahead. In this case, vehicle 110 includes a static (i.e., fixed) headlight system that is unable to adapt to the changing conditions of environment 100. These lighting limitations can severely limit the driver's ability to see important features on road 102 including an oncoming sharp curve, speed limit sign 150 indicating a safe speed for entering the curve, and oncoming vehicle 140 shown entering the curve from the opposite direction.

FIG. 2 shows various adaptive enhancements to the headlight system of vehicle 110, according to certain embodiments. FIG. 2 shows environment 200 including vehicle 110, road 102 with dip 104, approaching vehicle 140, and sign 150. Vehicle 110 includes left headlight beam 220 and right headlight beam 230.

Vehicle 110 includes a “smart” vehicle headlight system that may independently control each headlight, e.g., independently control the orientation of each headlight along two axes of rotation (e.g., left-to-right, up-and-down) or change a spread pattern (e.g., shape of headlight beam) to accommodate and adapt to changing environmental conditions. For example, as vehicle 110 is entering dip 104, headlight beams 220, 230 can be pitched upward beyond the upper slope of dip 104 to improve the driver's visual range and/or focus on a particular point-of-interest. In FIG. 2, headlight beam 220 is pitched upwards and spread wider with a focus on the upcoming curve and detected oncoming vehicle 140. The curve can be detected by sensors (discussed below), by trajectory (e.g., based on steering), by map information (e.g., GPS data), or a combination thereof. Some implementations may also sense and illuminate off-road features like signs (e.g., right headlight beam 230), animals, or the like, as would be appreciated by one of ordinary skill in the art. These are cursory examples of some of the embodiments disclosed herein, which are further discussed in greater detail below.

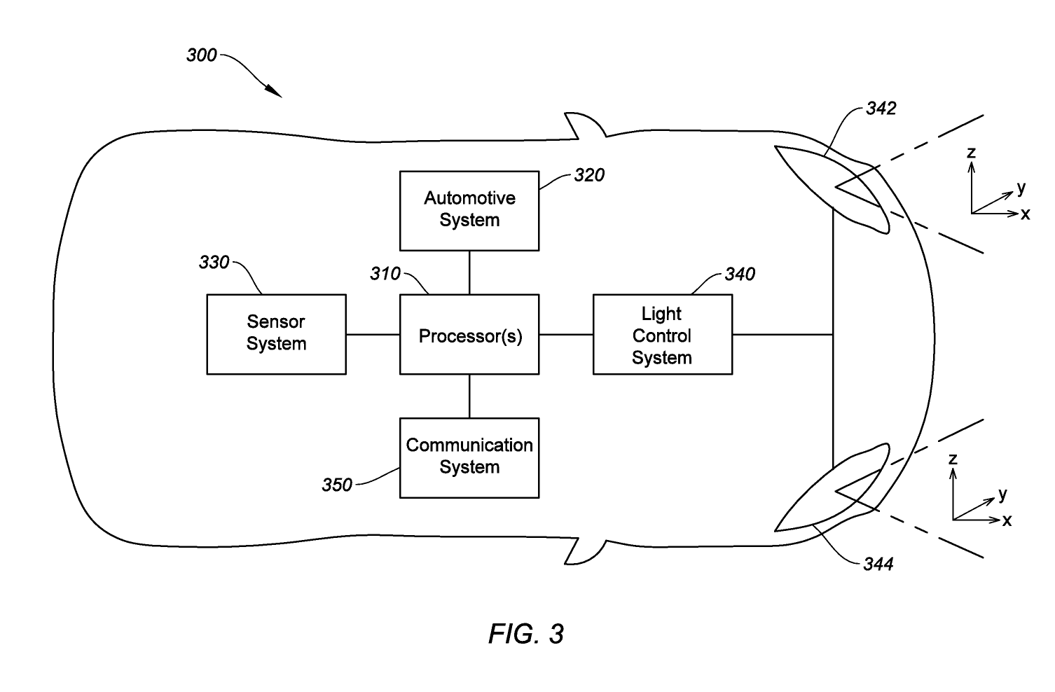

FIG. 3 shows a system 300 for a vehicle having smart beam lights for driving and environment assistance, according to certain embodiments. System 300 can include one or more processors 310, automotive system 320, sensor system 330, light control system 340, and communication system 350. More systems (or fewer systems) can be used, but have not been included in system 300 to prevent obfuscation of the novel concepts described herein. Furthermore, some systems may be combined with or subsumed by other systems. For instance, light control system 340 can be a part of automotive system 320, sensor system 330, etc., or combinations thereof. One of ordinary skill in the art would understand the many variations, modifications, and alternative embodiments, as well as the implementations thereof in the embodiments depicted and/or described herein.

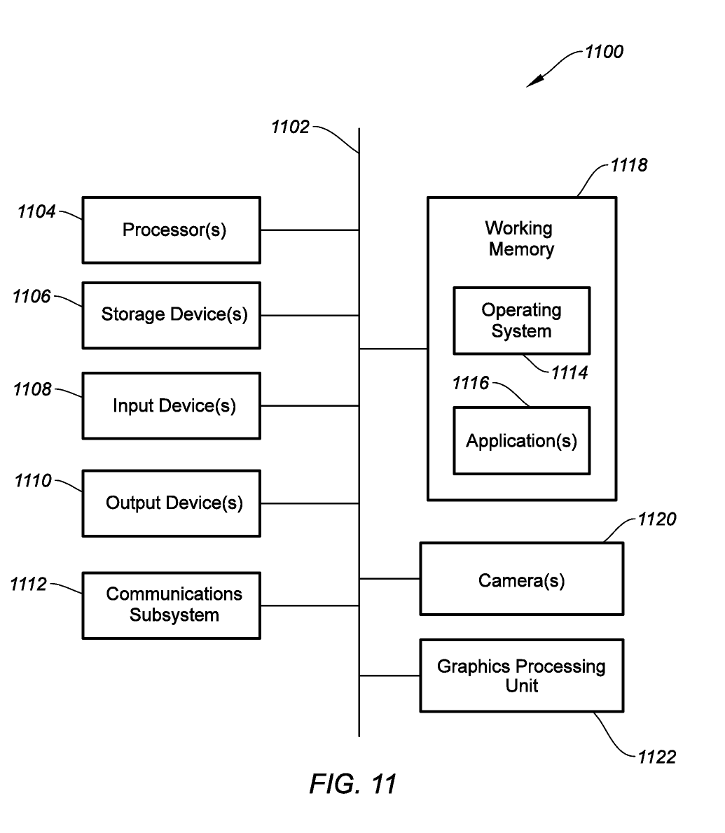

In some embodiments, processor(s) 310 can include one or more microprocessors (μCs) and may control the execution of software (e.g., logic, database management, access, and retrieval), controls, and communication between various electrical components of system 300. In some cases, processor(s) 310 may include one or more microcontrollers (MCUs), digital signal processors (DSPs), or the like, with supporting hardware and/or firmware (e.g., memory, programmable I/Os, etc.), as would be understood by one of ordinary skill in the art. Processor(s) 310 can include logic (e.g., instructions stored in memory (not shown), as described below with respect to FIG. 11) to control the various sensors, control systems, and the like.

In certain embodiments, automotive system 320 can control conventional automotive systems including engine and/or motor controls, heating and air conditioning controls, dynamic suspension controls, media controls, or the like, as would be understood by one of ordinary skill in the art. In some cases, automotive system 320 can be controlled, at least in part, by processor(s) 310.

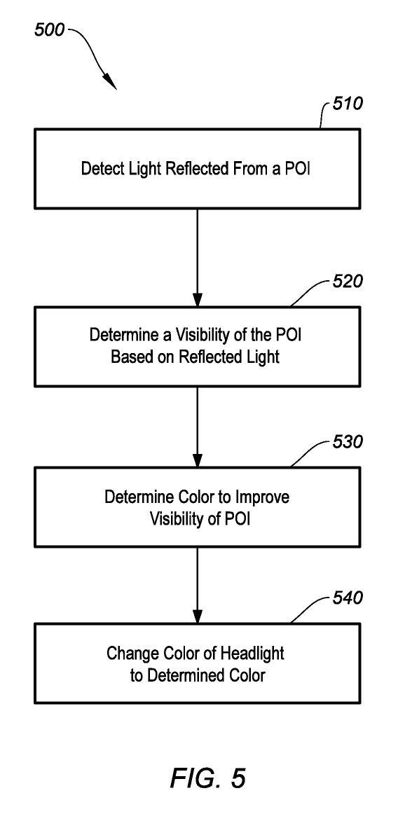

In some embodiments, sensor system 330 can control various sensors that may be used to detect road contours, climate conditions, object detection (e.g., signs, animals, people, inanimate objects, etc., and the like), and color detection (see, e.g., FIGS. 5 and 7A-7B). In some embodiments, sensors may include image-based sensors (e.g., video cameras), directional or orientation sensors (e.g., accelerometers, gyroscopes), RADAR, LIDAR, ultrasonic sensors, or the like. Image-based sensors (e.g., cameras) can be well-adapted to detect weather/climate conditions like rain, snow, fog, or the like. In some cases, sensor system 330 can be controlled, at least in part, by processor(s) 310.

In some embodiments, data (e.g., stored data, streaming data, etc.) can be used to help determine a color of an object. For example, traffic signs are typically assigned a particular color depending on the type of sign (e.g., white for speed limit, yellow for warning, orange for temporary traffic control, red for regulatory signs, blue for motorist/recreational signs, etc.). This information can be used to determine what beam light color to use to improve the visibility of the reflected image of the sign, as discussed below. In some cases, an image sensor can be used to collect a color of stationary object in the daytime and use that information to inform an appropriate headlight beam color for improved visibility at night time.

In certain embodiments, light control system 340 can control headlights 342, 344. Some systems 300 can include a different number of headlights (e.g., 3 or more) or may include other lighting systems (e.g., fog lights, running lights, braking lights, etc.), which can be controlled by light control system 340. Light control system 340 may control any number of light-related parameters including an orientation of a headlight (e.g., via an actuator system) in two axes of rotation (e.g., left/right and up/down), a brightness, a color or color pattern, an illumination pattern (e.g., shape of headlight beam, strobe pattern, etc.), or the like. Headlights 342, 344 can be independently controlled by light control system 340 such that one headlight is oriented towards a first POI (e.g., a curve in the road), while the second headlight is simultaneously oriented toward a second POI (e.g., a road sign) that is located in a different direction, as depicted in FIG. 2. In some implementations, light control system 340 can control headlights 342, 344 by one or more actuator systems (e.g., a first control system and a second control system) to mechanically manipulate their orientation, although other control mechanisms are possible. Light control system 340 can be controlled, at least in part, by processor(s) 310. In some embodiments, headlights 342, 344 can be Xenon lights, LED-based lights, halogen-based lights, or other suitable type, as would be understood by one of ordinary skill in the art.

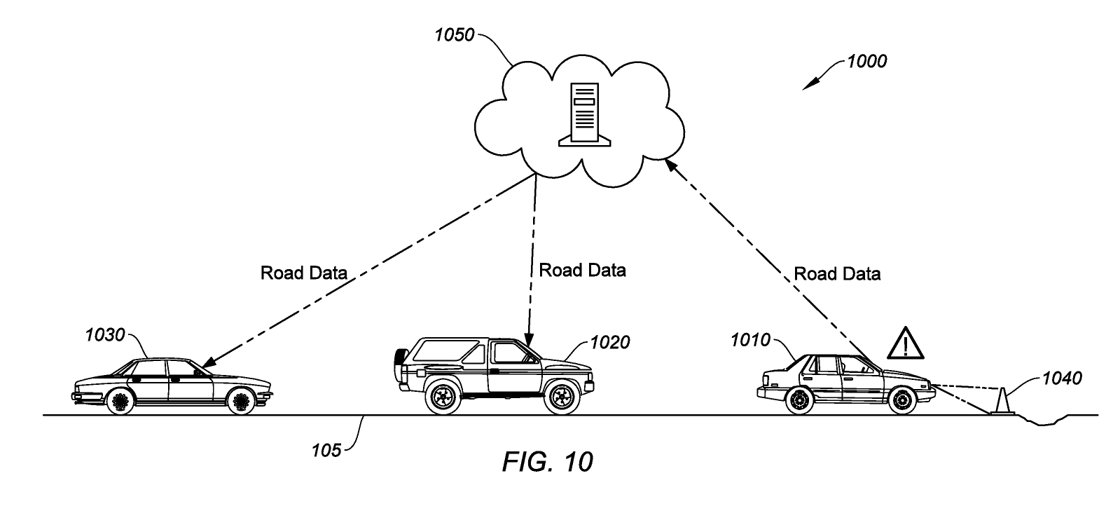

In some embodiments, communication system 350 can serve as an interface for communicating data between system 300 and other computer systems or networks (e.g., in the cloud), and the like, as further discussed below in FIGS. 10-11. Embodiments of communications subsystem 912 can include wired interfaces (e.g., Ethernet, CAN, RS232, RS485, etc.) or wireless interfaces (e.g., ZigBee, Wi-Fi, cellular, etc.). In some cases, system 350 can include a global position system (GPS) to receive position data corresponding to a location of system 300 (i.e., vehicle 110), which can be used to orient the first or second headlight toward certain GPS or high-definition GPS-identifiable features (e.g., road contours, signs, points-of-interest, and the like), as would be understood by one of ordinary skill in the art.

### Independent Control of Headlights and Multiple POIs

The following embodiment provides a non-limiting example of an adaptive headlight system that can simultaneously control and orient a first headlight towards a first POI and a second headlight towards a second POI based on received sensor data (e.g., image data) to dynamically adjust to environmental conditions in real-time.

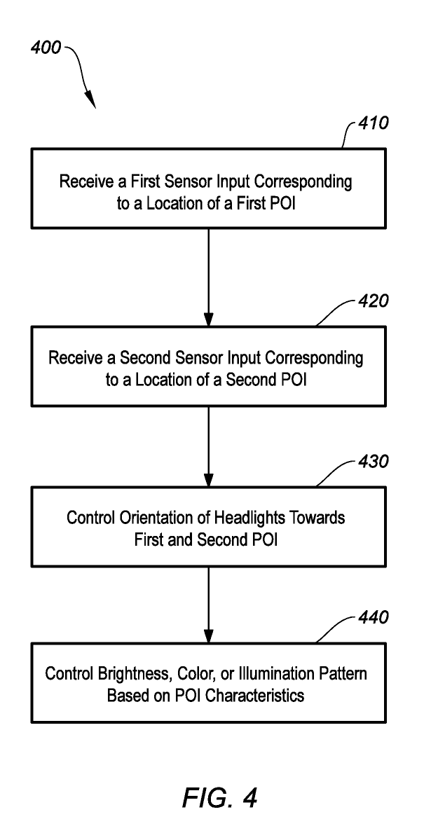

FIG. 4 shows a simplified flow chart illustrating a method 400 for controlling adaptive headlights in a vehicle, according to certain embodiments. Methods 400, 500, and 600 (further discussed below) can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, methods 400-600 can be performed by processor(s) 310 of system 300, aspects of system 1100, combinations thereof, or other suitable computing device.

At step 410, method 400 can include receiving a first sensor input corresponding to a location of a first point-of-interest (POI). The sensor input can include sensor data from a digital camera or other suitable image sensor for computer vision, which may be controlled by sensor system 330, processor 310, or a combination thereof. POI data can include road features, such as a road contour (e.g., pitch, roll, yaw, curves, embankments, etc.), road conditions (e.g., pot holes, flooded roads, ice/snow covered roads, bumpy roads, large rocks in the roadway, etc.), off-road features (e.g., road signs, landmarks, etc.), moving objects (e.g., soccer ball, people, etc.), or the like, as would be appreciated by one of ordinary skill in the art. In some cases, a POI can include multiple features treated as a single POI (e.g., an approaching curve in the road and an oncoming vehicle (140) as shown in FIG. 2).

At step 420, method 400 can include receiving a second sensor input corresponding to a location of a second POI. By way of example, a second sensor input can be an image-based input and the second POI can be a road sign (150), as described above with respect to FIG. 2.

At step 430, method 400 can include simultaneously controlling (e.g., by processor 310 and/or light control system 340) an orientation of a first adjustable headlight toward the first POI, and an orientation of a second adjustable headlight toward the second POI, where the first POI is at a different location than the second POI. In other words, a first headlight (e.g., headlight 342) can be controlled independently from a second headlight (e.g., headlight 344) such that they are not necessarily synchronized and can be simultaneously focused on different POIs.

At step 440, method 400 can include simultaneously controlling at least one of a brightness of each of the first and second adjustable headlights, a color of each of the first and second adjustable headlights, or an illumination pattern of each of the first and second adjustable headlights.

In certain embodiments, the brightness of a headlight can be controlled in a quantized manner (e.g., low beams, high beams), in a continuum (e.g., a high-resolution setting ranging from a low brightness to a high brightness level), or some combination thereof. For example, low brightness levels may be used in high traffic areas (e.g., traffic jams) and enclosed spaces (e.g., tunnels—see, e.g., FIGS. 8A-8B), and high brightness levels may be used on open roads with no detected approaching vehicles or areas with very poor lighting. One of ordinary skill in the art would understand the many variations, modifications, and alternative embodiments thereof.

In certain embodiments, changing the color of a headlight can be used to improve the appearance of a POI such that it may be more easily seen by the driver. For example, some colors may be hard to see in particular lighting conditions (e.g., yellow lettering on a sign under yellow street lamps). In these conditions, light control system 340 can cause one or more headlights 342, 344 to change to a color that causes the reflected image to be more easily seen by the driver. This is further discussed below with respect to FIGS. 5 and 7A-7B.

In some embodiments, changing the illumination pattern of a headlight can include changing the shape of a beam pattern (e.g., width, height, contour, etc.). With LED-based lights, any suitable shape can be made including non-continuous patterns (e.g., rows/columns of light with spaces between them). Further, any continuous (e.g., oscillating brightness) or non-continuous (e.g., strobe-pattern) illumination patterns are possible, as would be understood by one of ordinary skill in the art.

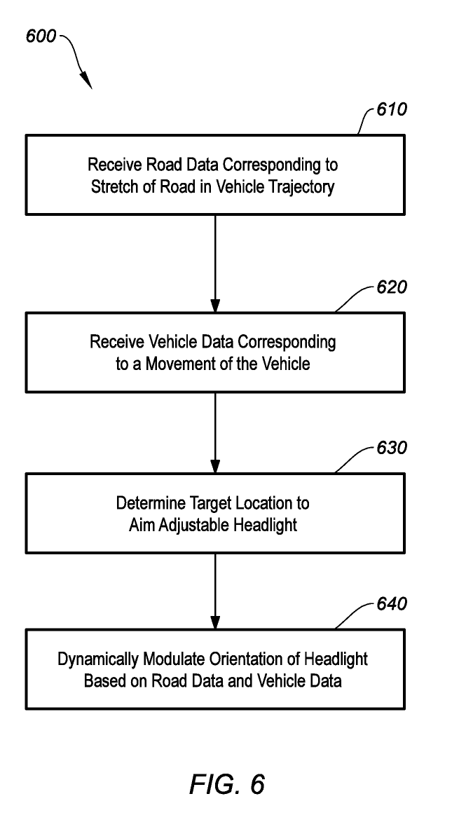

It should be appreciated that the specific steps illustrated in FIG. 4 provide a particular method 400 of controlling adaptive headlights in a vehicle, according to certain embodiments. Other sequences of steps may also be performed according to alternative embodiments. For example, alternative embodiments may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. For example, GPS data can be used in addition to or in lieu of sensor input data to control the orientation of the headlights towards one or more POIs, as further discussed below with respect to FIG. 6. Some examples of GPS-based automatic adjustments of headlights include increasing a pitch of a headlight when a road contour starts moving uphill, and pitching the headlight down when the road contour starts going downhill; highlighting a GPS-identified road feature (e.g., bump, road sign); reorienting the headlights toward a center of a driver's lane in closed-environments (e.g., tunnels); automatically focusing the headlights on GPS-identified emergency resources (e.g., emergency phone box) when there is a detected mechanical problem with the vehicle, or the like. GPS is just one example of how “map-assisted” control of smart headlights can be implemented. Positioning (i.e., determining a present location) can be achieved by a host of other technologies including GNSS, GLONASS, and BeiDou, to name a few, as would be understood by one of ordinary skill in the art.

In some cases, crowd-shared, cloud-based data can be used with or in lieu of GPS data. One of ordinary skill in the art would recognize and appreciate many variations, modifications, and alternatives of method 400.

### Using Color to Improve the Visibility of a POI

The following embodiment provides a non-limiting example of an adaptive headlight system that can be used to improve the visibility of a POI by changing the color of a headlight beam to cause the reflected image to be more easily seen by the driver.

FIG. 5 shows a simplified flow chart illustrating a method 500 for improving the visibility of a POI by changing a color of a headlight beam, according to certain embodiments. At step 510, method 500 can include detecting, by a sensor (e.g., controlled by processor 310 or light control system 340), light reflected from a POI. The sensor can be an image-based sensor that detects light in the visible spectrum.

At step 520, method 500 can include determining a visibility of the POI based on the reflected light. In some embodiments, this can be done by analyzing the chromatic content of the reflected POI (e.g., road sign) and determining the visibility of the POI based, in part, on the chromatic content. For instance, some colors (i.e., chromatic content) are hard to see under certain lighting conditions. The visibility of the POI can be based on other factors including, but not limited to, the brightness, size, and/or location of the reflected light from the POI. The reflected light can be light originating from the vehicle (110) headlights, from the headlights of another car (e.g., vehicle 140), from natural light (e.g., from the sun or moon), or other ambient light sources (e.g., artificial light).

At step 530, method 500 can include determining one or more colors associated with the POI based on the light reflected from the POI and determining a color (or colors) that, when combined with the one or more colors associated with the POI, improves the visibility of the POI.

At step 540, method 500 can include changing a color of an adjustable headlight to the determined color to improve the visibility of the POI. In some embodiments, multiple colors may be used and other novel features described herein (e.g., changing the brightness, illumination pattern, etc.) can be used in conjunction with color changes to improve the visibility of the POI. Aspects of method 500 are further discussed below with respect to FIGS. 7A-7B.

It should be appreciated that the specific steps illustrated in FIG. 5 provide a particular method 500 of improving the visibility of a POI by changing a color of a headlight beam, according to certain embodiments. Other sequences of steps may also be performed according to alternative embodiments. For example, alternative embodiments may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. For example, sensor inputs can be used to locate a POI and orient the adjustable headlights toward the POI, as described above with respect to FIGS. 2-4. One of ordinary skill in the art would recognize and appreciate many variations, modifications, and alternatives of method 500.

### Using High-Definition Maps to Control Orientation of Headlights

The following embodiment provides a non-limiting example of an adaptive headlight system that can be used to control an orientation of a headlight based on high-definition road data (e.g., pitch, roll, and yaw of roads, embankments, etc.) and vehicle data (e.g., velocity, acceleration) to provide real-time, high precision headlight beam control over a varying terrain.

FIG. 6 shows a simplified flow chart for a method 600 of operating an adaptive headlight system to dynamically modulate an orientation of a headlight system based on high-definition road and vehicle data, according to certain embodiments.

At step 610, method 600 can include receiving road data corresponding to a stretch of road in a vehicle's trajectory. The road data can include any type of data that defines the contours of the road including road pitch data, road roll data, and road yaw data. The road data can define how a road swerves, banks, twists, and turns with any suitable resolution (e.g., accurate within 1 cm, 1 m, 10 m, etc.). The road data can be received by on-board sensors (e.g., image based sensors, gyroscopes, etc.) that can be used to detect the contours of the underlying stretch of road, by high-definition GPS that provides detailed road contour data (e.g., road pitch, roll, yaw, etc.), or other suitable source of data, as would be appreciated by one of ordinary skill in the art.

At step 620, method 600 can include receiving vehicle data corresponding to a movement of the vehicle. Vehicle data can include vehicle velocity data, vehicle acceleration data, orientation data, or the like. Vehicle velocity data can be provided by conventional hardware (e.g., wheel sensors) and/or software associated with automotive system 320. Acceleration data can be provided by an accelerometer or other suitable measuring device. Orientation data can be provided by a gyroscope, GPS data, or other suitable system, as would be understood by one of ordinary skill in the art.

At step 630, method 600 can include determining a target location (e.g., POI) to aim the adjustable headlight. For instance, a target location may be a typical distance in front of the vehicle (e.g., like conventional headlights systems). The target location can be any suitable POI (road feature/location, road sign, moving object, etc.). In some cases, multiple target locations can be determined for simultaneously orienting multiple headlights toward different POIs, as discussed above with respect to FIGS. 2-4.

At step 640, method 600 can include controlling an orientation of an adjustable headlight based on the road data and vehicle data, and dynamically modulating the orientation of the adjustable headlight(s) (e.g., headlights 342, 344) in real-time to maintain a focus of the adjustable headlight on the target location as new road data and vehicle data is received.

It should be appreciated that the specific steps illustrated in FIG. 6 provide a particular method 600 of operating an adaptive headlight system to dynamically modulate an orientation of a headlight system based on high-definition road and vehicle data, according to certain embodiments. Other sequences of steps may also be performed according to alternative embodiments. For example, alternative embodiments may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of method 600.

### Example of Modifying Headlight Color to Improve Visibility of a POI

FIG. 7A shows a simplified diagram 700 showing a cabin view of an adaptive headlight system, according to certain embodiments. Diagram 700 includes road 710, road sign 720, oncoming vehicle 730, left headlight beam 740, and right headlight beam 750. As shown, right headlight beam 750 can be oriented toward road sign 720 as left headlight beam 740 remains directed to road 710. The detection of road sign 720 (e.g., POI) and the independent and adaptive orientation of headlight beam 740 toward road sign 720 is further discussed above with respect to FIGS. 2-4.

In this example, road sign 720 is still difficult to see despite the direct illumination provided by right headlight beam 750. The poor visibility of road sign 720 may be attributable to a number of factors, which may include poor weather conditions (e.g., fog, rain, dust, etc.), interference from natural light (e.g., direct sunlight) or artificial light sources (e.g., headlight beams from oncoming car 730), road sign colors that do not reflect light well (e.g., in the present weather and/or lighting conditions), or the like. Aspects of the invention can change a color of headlight beam 750 to improve its visibility, as shown in FIG. 7B, by detecting light reflected from the POI (e.g., road sign 720), determining a visibility of the POI based on the reflected light (e.g., including the factors listed above), determining a color that, when directed to the POI, causes the reflected image to have an improved visibility for the POI, and changing the color of the headlight beam to the determined color (e.g., right headlight beam 780). In some cases, multiple headlights and/or colors can be used, as would be appreciated by one of ordinary skill in the art.

In certain embodiments, system 300 may receive information indicating that a particular road feature (e.g., road sign) is not well recognized in an existing database. System 300 can direct one of headlights 342, 344 toward the road feature such that system 300's computer vision resources (e.g., image-based sensors—operated by sensor system 330) can better detect physical features (e.g., size, precise location, color, text, etc.) of the road sign.

In some embodiments, color can be used to draw the driver's attention to a particular POI or alert the driver to potential hazards. For instance, system 300 may receive data indicating that a crash has occurred a mile ahead and there is wreckage in the street. Headlight beams 740, 750 can be directed to the hazard in a different color (e.g., red) in a strobed fashion to alert the driver to slow down and drive with caution. One of ordinary skill in the art would understand the many variations, modifications, and alternative embodiments thereof.

### Example of Headlight Beam Control to Adapt to Environmental Conditions

FIG. 8A shows a simplified diagram 800 showing a cabin view of an adaptive headlight system operating in a closed-space environment. Diagram 800 includes road 810, tunnel walls 820, oncoming vehicle 830, left headlight beam 840, and right headlight beam 850. In some closed-space environments, headlight beams reflected off of walls or ceilings (e.g., tunnel walls) may be redirected toward the windshield of another driver, which may adversely impact the other driver's vision, as shown in FIG. 8A, or even the driver of the offending vehicle.

In some embodiments, one or more sensors, GPS data, or other data source can be used to determine when a vehicle is inside a closed-space environment, such as tunnel 820. For example, certain image-based and/or acoustic-based sensors may generate data that can be used (e.g., by logic executed by processor 310) to determine when the vehicle is in a closed-space environment. GPS data may be used alone or in combination with vehicle sensors, as discussed above. In some embodiments, when a closed-space environment is detected, headlights 840, 850 can be redirected and/or reshaped to better adapt to the surroundings, as shown in FIG. 8B with left headlight beam 870 and right headlight beam 880.

More generally, system 300 may detect a type of environment the vehicle is operating in (e.g., a tunnel), and control a light spread pattern of at least one adjustable headlight based on the detected type of environment. For example, a first light spread pattern may be used when the detected environment is an open-space environment, such as environment 100 of FIG. 1. A second spread pattern may be used when the detected environment is a closed-space environment, which can include a tunnel, garage, or other enclosed structure. Any type of spread pattern or number of spread patterns may be used, which may be selected based on other criteria other than the open/closed environment analysis. For instance, beam spreading may be adjusted in response to certain lighting conditions, detected object conditions (e.g., color, size, etc.), or any other suitable metric, as would be appreciated by one of ordinary skill in the art.

Certain aspects shown and described with respect to FIGS. 8A and 8B can be performed by system 300, system 1100, by another suitable computing system (e.g., via cloud computing), and/or any combination thereof.

### Example of Adaptive Headlight Beam Control for Environmental Assistance

FIG. 9 shows a simplified diagram 900 of cabin view of an adaptive headlight system 300 providing environment assistance to a pedestrian, according to certain embodiments. Diagram 900 depicts pedestrian 910 walking across cross-walk 920 on road 930 as the driver waits at a stop sign or stop light. System 300 can detect pedestrian 910 (e.g., using a camera or other image-based sensing device) based on a number of factors including, but not limited to, a size, speed (e.g., velocity), trajectory, and location. For example, system 300 may determine (e.g., using image-based sensors) that pedestrian 310 is a person because he is about the average size of a human (e.g., 1.8 meters), he is moving at a typical walking speed (e.g., 1.5 m/s), in a location that pedestrians typically walk across on road 930 (e.g., cross-walk 920), which may be identified via GPS data, sensor data, or the like. Once pedestrian 910 is identified, headlight beams 940, 950 can be modified and/or oriented to assist the pedestrian by highlighting his path. For example, right headlight beam 950 may be oriented towards pedestrian 910 to illuminate him so other drivers can more easily see him, and left headlight beam 940 can be widened and directed to a portion of cross-walk 920 in the immediate path of pedestrian 910. FIG. 9 depicts one example of many possible uses of the adaptive headlight system described herein. For example, system 300 can identify a bicyclist on the side of the road using similar criteria (e.g., image data corresponding to a moving object having a particular size, speed, and the like) and light the bicyclist's path in a similar fashion. One of ordinary skill in the art would understand the many variations, modifications, and alternative embodiments thereof.

### Cloud-Based Sharing and Machine Learning

FIG. 10 shows a simplified diagram 1000 showing a number of vehicles communicatively coupled through a cloud-based network 1050, according to certain embodiments. Vehicles 1010, 1020, and 1030 are shown driving on road 1005. In some embodiments, vehicle 1010 can detect construction cone 1040 placed near a pothole in road 1005. As described above, vehicle 1010 can adaptively orient one or more headlights towards cone 1040 (e.g., a POI) and alert the driver so that corrective action can be taken to avoid the pothole. In addition, vehicle 1010 may communicate information about cone 1040 and the corresponding pothole (e.g., location and size of objects) to a cloud-based network that can, in turn, communicate the data to vehicles 1020 and 1030. Thus, vehicles 1020 and 1030 can incorporate POI data through machine learning via crowd-sourced data received from any suitable source including cloud 1050, updates via mobile devices (e.g., mobile phone, laptop computer, etc.), thumb drive, or the like.

In some embodiments, these cloud-based alerts can be applied to any number of scenarios. For instance, roadside emergencies (e.g., car accidents, debris in road, etc.) can be communicated to other vehicles and their corresponding systems 300 can illuminate the roadside emergency to alert the driver that it is approaching.

In some embodiments, cloud 740 may contain logic (as described above), a database, and one or more processors to execute some or all aspects of system 300 discussed above. For example, system 300 of vehicle 110 may receive image data from on-board sensors and transfer it to a cloud-based server perform the computational steps (e.g., methods 400-600) of determining a POI and calculating the necessary mechanical operations to orient one or more headlight beams toward the POI, as described above. Cloud 1050 can be any suitable size of networked computing devices that may be configured to share computational resources. The many variations and alternatives of sharing resources between individual vehicles (e.g., vehicles 1010-1030) and cloud 1050 would be understood by one of ordinary skill in the art.

FIG. 11 shows computer system 1100 for controlling an adaptive vehicle headlight system, according to certain embodiments. Computer system 1100 can be used to implement and/or control any of the computer systems/devices (e.g., sensors, headlights, communication systems, etc.) described with respect to FIG. 3. As shown in FIG. 11, computer system 1100 can include one or more processors 1104 to communicate with a number of peripheral devices via a bus subsystem 1102. These peripheral devices can include storage devices 1106 (including long term storage and working memory), user input devices 1108 (e.g. image-based sensors), user output devices 1110 (e.g., video display to alert user to POI), and communications subsystems 1112.

In some embodiments, a graphics processing unit (GPU) 1122 can operate independently or in conjunction with processor(s) 1106 to control one or more output devices 1110. For example, output devices 1110 may include one or more displays in a vehicle. GPU 1122 and/or processors 1104 may control graphics, user interface characteristics, or other display-based functions, as would be appreciated by one of ordinary skill in the art.

In some examples, internal bus subsystem 1102 can provide a mechanism for letting the various components and subsystems of computer system 1100 communicate with each other as intended. Although internal bus subsystem 1102 is shown schematically as a single bus, alternative embodiments of the bus subsystem can utilize multiple buses. Additionally, communications subsystem 1112 can serve as an interface for communicating data between computer system 1100 and other computer systems or networks (e.g., in the cloud). Embodiments of communications subsystem 1112 can include wired interfaces (e.g., Ethernet, CAN, RS232, RS485, etc.) or wireless interfaces (e.g., ZigBee, Wi-Fi, cellular, etc.).

In some cases, user interface input devices 1108 can include a microphone, keyboard, pointing devices (e.g., mouse, trackball, touchpad, etc.), a barcode scanner, a touch-screen incorporated into a display, audio input devices (e.g., voice recognition systems, etc.), Human Machine Interfaces (HMI) and other types of input devices. In general, use of the term “input device” is intended to include all possible types of devices and mechanisms for inputting information into computer system 1100. Additionally, user interface output devices 1110 can include a display subsystem or non-visual displays such as audio output devices, etc. The display subsystem can be any known type of display device. In general, use of the term “output device” is intended to include all possible types of devices and mechanisms for outputting information from computer system 1100.

Storage devices 1106 can include memory subsystems and file/disk storage subsystems (not shown), which can be non-transitory computer-readable storage media that can store program code and/or data that provide the functionality of embodiments of the present disclosure (e.g., method 800). In some embodiments, storage devices 1106 can include a number of memories including main random access memory (RAM) for storage of instructions and data during program execution and read-only memory (ROM) in which fixed instructions may be stored. Storage devices 1106 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

Computer system 1100 can also include software elements, shown as being currently located within working memory 1118, including an operating system 1114, device drivers, executable libraries, and/or other code, such as one or more application programs 1116, which may comprise computer programs provided by various implementations, and/or may be designed to implement methods, and/or configure systems, provided by other implementations, as described herein. Merely by way of example, one or more procedures described with respect to the method(s) discussed above (e.g., methods 400-600) might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1106 described above. In some cases, the storage medium might be incorporated within a computer system, such as computer system 1100. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by computer system 1100 and/or might take the form of source and/or installable code, which, upon compilation and/or installation on computer system 1100 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of computer system 1100 may be omitted or may be implemented separate from the illustrated system. For example, processor(s) 1104 and/or other elements may be implemented separate from input device 1108. In one implementation, the processor may be configured to receive images from one or more image-based sensors (e.g., video cameras).

Some implementations may employ a computer system (such as computer system 1100) to perform methods in accordance with the disclosure. For example, some or all of the procedures of the described methods (e.g., methods 400-600) may be performed by computer system 1100 in response to processor 1104 executing one or more sequences of one or more instructions (which might be incorporated into operating system 1114 and/or other code, such as an application program 1116) contained in the working memory 1118. Such instructions may be read into working memory 1118 from another computer-readable medium, such as one or more of storage device(s) 1106. Merely by way of example, execution of the sequences of instructions contained in working memory 1118 might cause processor(s) 1104 to perform one or more procedures of the methods described herein.

The terms “machine-readable medium” and “computer-readable medium,” as used herein, refer to any medium that participates in providing data that causes a machine to operate in a specific fashion. In some implementations implemented using computer system 1100, various computer-readable media might be involved in providing instructions/code to processor(s) 1104 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 1106. Volatile media include, without limitation, dynamic memory, such as working memory 1118. Transmission media include, without limitation, coaxial cables, copper wire, and fiber optics, including the wires that comprise bus 1102, as well as the various components of communications subsystem 1112 (and/or the media by which communications subsystem 1112 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to processor(s) 1104 for execution. Merely by way of example, the instructions may initially be carried on a magnetic disk and/or optical disc of a remote computer. A remote computer might load the instructions into its dynamic memory and send the instructions as signals over a transmission medium to be received and/or executed by computer system 1100. These signals, which might be in the form of electromagnetic signals, acoustic signals, optical signals and/or the like, are all examples of carrier waves on which instructions can be encoded, in accordance with various implementations of the invention.

Computer system 1100 might also include a communications subsystem 1112, which can include without limitation, a modem, a network card (wireless or wired), an infrared communication device, a wireless communication device and/or chipset (such as a Bluetooth device, an 802.11 device, a WiFi device, a WiMax device, cellular communication facilities, etc.), and/or the like. Communications subsystem 1112 may permit data to be exchanged with a network, other computer systems, and/or any other devices described herein. In many implementations, computer system 1100 can further comprise a non-transitory working memory 1118, which can include a RAM or ROM device, as described above.

In some embodiments, camera(s) 1120 can include type of image based sensor or video system including, but not limited to, digital camera systems, IR sensors, LIDAR systems, audio-based systems (e.g., ultrasonic, sonar, etc.), or the like. For example, camera(s) 1120 can include the image-based sensors discussed above with respect to FIGS. 2-4.

It should be appreciated that computer system 1100 is illustrative and not intended to limit embodiments of the present disclosure. Many other configurations having more or fewer components than system 1100 are possible. Further, computer system 1100 may be combined with, subsumed by in part or in whole, or otherwise used in conjunction with system 300, as would be understood by one of ordinary skill in the art with the benefit of this disclosure.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local area network, a wide-area network, a virtual private network, the Internet, an intranet, an extranet, a public switched telephone network, an infrared network, a wireless network, and any combination thereof. Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments. However, computer-readable storage media does not include transitory media such as carrier waves or the like.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

What is claimed is:

1. A vehicle headlight system for a vehicle comprising:
a first headlight having a first control system to control an orientation of the first headlight;
a second headlight having a second control system to control an orientation of the second headlight; and
a processor to control the first and second control systems,
wherein the processor is operable to orient the first headlight toward a first point-of-interest (POI), and simultaneously orient the second headlight toward a second POI that is different than the first POI.

2. The vehicle headlight system of claim 1 wherein the first POI and the second POI each include at least one of a road feature, a sign, or a moving object.

3. The vehicle headlight system of claim 1 wherein the processor further controls:
a brightness of each of the first and second headlights;
a color of each of the first and second headlights; and
an illumination pattern of each of the first and second headlights.

4. The vehicle headlight system of claim 1 wherein the first and second control systems are actuator systems to control the orientation of the first and second headlight in two axes of rotation.

5. The vehicle headlight system of claim 1 further comprising:
a global position system (GPS) to receive position data corresponding to:
a location of the vehicle; and
POI data,
wherein the processor uses the POI data, at least in part, to orient the first or second headlight when the first or second POI in included in the POI data.

6. A method of operating a vehicle headlight system for a vehicle, the method comprising:
receiving, by a processor, a first sensor input corresponding to a location of a first point-of-interest (POI);
receiving, by the processor, a second sensor input corresponding to a location of a second point-of-interest (POI);
simultaneously controlling, by the processor:
a focus of a first adjustable headlight toward the first POI; and
a focus of a second adjustable headlight toward the second POI,
wherein the first POI is different than the second POI.

7. The method of claim 6 wherein the first POI and the second POI each include at least one of a road feature, a sign, or a moving object.

8. The method of claim 6 further comprising:
simultaneously controlling, by the processor, at least one of:
a brightness of each of the first and second adjustable headlights;
a color of each of the first and second adjustable headlights; or
an illumination pattern of each of the first and second adjustable headlights.

9. The method of claim 6 further comprising:
receiving, by the processor from a GPS, position data corresponding to a location of the vehicle, and POI data,
wherein the controlling of the first and second adjustable headlights is based, in part, on the POI data.

10. The method of claim 6 wherein the first and second adjustable headlights are controlled by actuator systems to control the focus of the first and second headlight in two axes of rotation.

11. A method of operating a vehicle headlight system for a vehicle, the method comprising:
detecting, by a sensor controlled by a processor, light reflected from a POI;
determining, by the processor, a visibility of the POI based on the light reflected from the POI; and
changing a color of an adjustable headlight to improve the visibility of the POI.

12. The method of claim 11 further comprising:
receiving, by a processor, a sensor input corresponding to a location of the POI; and
controlling, by the processor, an orientation of the adjustable headlight toward the POI.

13. The method of claim 11 further comprising:
determining, by the processor, one or more colors associated with the POI based on the light reflected from the POI; and
determining, by the processor, a color that, when combined with the one or more colors associated with the POI, improves the visibility of the POI,
wherein changing the color of the adjustable headlight includes changing the color to the determined color.
